(19) United States
(12) Patent Application Publication
(10) Pub. No.: US 2025/0336565 A1
(43) Pub. Date: Oct. 30, 2025

(54) Method of Manufacturing a Three-Core Power Cable

(71) Applicant: NKT HV Cables AB, Lyckeby (SE)

(72) Inventors: Joel Johnsson, Kalmar (SE); Henrik Ekholm, Listerby (SE); Denny Tjahjanto, Sundbyberg (SE)

(21) Appl. No.: 19/184,077

(22) Filed: Apr. 21, 2025

(30) Foreign Application Priority Data
Apr. 30, 2024 (EP) 24173283.3

(51) Int. Cl. H01B 5/10; H01B 13/32

(52) U.S. Cl. CPC H01B 5/10; H01B 13/32

(57) ABSTRACT

Method of manufacturing a power cable including three cores and three filler profiles arranged in a stranded configuration, the method including: A) in a design stage of the power cable: A0) defining a nominal outer diameter of the cores, and defining a stranding pitch P of the cores, A1) determining, in a transverse plane of the power cable, a shape of at least one of the cores, A2) determining a cross-sectional shape of the filler profiles in a transverse section of a filler profile based on the shape determined in step A1), B) in the production stage of the power cable: B1) manufacturing each of the cores with the nominal outer diameter, B2) obtaining the filler profiles with the cross-sectional shape obtained in step A2), and B3) stranding the cores and the filler profiles with the stranding pitch P in an assembly machine.

### TECHNICAL FIELD

The present disclosure generally relates to three-core power cables with filler profiles.

### BACKGROUND

Power cables may comprise several cores, each being circular in cross-section. A power cable may for example comprise three cores that are stranded together to, in cross-section, form a trefoil configuration. To make the power cable circular or essentially circular in cross-section, and to provide radial stability, filler elements may be stranded with the cores.

The filler elements may be of a type that have an arced outer surface and two curved inner surfaces, as disclosed in for example EP3097446. The inner arced surfaces form part of a circle which matches the diameter of the cores.

While the inner arced surfaces theoretically should fit well with the outer surface of the cores, this may not always be the case. Hereto, the present inventors have realised that the level of matching depends on the stranding pitch/helix angle of the cores in their stranded state. In particular, in a transverse section of a three-core power cable, i.e., in a cross-section at a 90 degrees angle in relation to the longitudinal axis of the power cable, the cylindrical cores are in fact not circular because of the helix angle. The cross-sectional shape is instead approximately elliptical. Thus, arced outer surfaces of a filler element may not always match perfectly with the outer surface of the cores. The pressure provided by the filler elements onto the cores may therefore not be even and this may risk damaging the power cable especially when large radial forces are applied to the power cable such as during cable laying from an offshore vessel or during cable installation at landfall. This may especially be the case for higher nominal voltages such 100 kV and above, which require larger and thus heavier power cable, and/or for deep-sea installations.

### SUMMARY

In view of the above an object of the present disclosure is to provide a method of manufacturing a power cable which solves or at least mitigates the problems of the prior art.

There is hence according to a first aspect of the present disclosure provided a method of manufacturing a power cable comprising three cores and three filler profiles arranged in a stranded configuration, the method comprising: A) in a design stage of the power cable: A0) defining a nominal outer diameter of the cores, and defining a stranding pitch P of the cores, A1) determining, in a transverse plane of the power cable, a shape of at least one of the cores, A2) determining a cross-sectional shape of the filler profiles in a transverse section of a filler profile based on the shape determined in step A1), B) in the production stage of the power cable: B1) manufacturing each of the cores with the nominal outer diameter, B2) obtaining the filler profiles with the cross-sectional shape obtained in step A2), and B3) stranding the cores and the filler profiles with the stranding pitch P in an assembly machine.

The power cable manufactured according to the method will thus have a tailored fit between the filler profiles and the cores. The pressure by the filler profiles onto the cores is therefore more evenly distributed, which reduces the risk of the cores being damaged by the filler profiles during cable laying.

Moreover, the outer dimensions of the manufactured power cable can be known beforehand, i.e., before the power cable has been manufactured. Additionally, because of the better fit, the outer diameter of the power cable 13 can be made smaller which means a longer section of a power cable can be stored on a cable laying vessel, and material can be saved because cable layers outside the filler profiles require less material. The power cable can thus become lighter because less armour—if present—is required due to the smaller outer diameter.

One embodiment comprises prior to step A2) estimating a three-core outer dimension of an assembly comprising the stranded cores, based on the shape obtained in step A1), wherein in step A2) the cross-sectional shape is further based on the three-core outer dimension.

According to one embodiment in cross-section, each filler profile has a curved outer boundary and two curved inner boundaries, wherein the curved outer boundary forms an outer boundary of the filler profile and connects the two curved inner boundaries, each of which is adapted to bear against an outer surface of a respective core.

According to one embodiment the determining in step A2) involves determining a curvature of each of the two curved inner boundaries to match with the shape of the core.

According to one embodiment in step A2) the determining the cross-sectional shape of the filler profiles in a transverse section of a filler profile involves scaling at least one of the curvatures by means of the cosine of a core stranding angle of the cores. The scaling of at least one of the curvatures is by multiplication with the cosine of the core stranding angle of the cores.

According to one embodiment the shape of the core is an ellipse, wherein step A1 involves determining the major diameter and the minor diameter of the ellipse.

One embodiment comprises, prior to step A2), determining an average diameter based on an average of the major diameter and the minor diameter, wherein in step A2) the cross-sectional shape is determined based on the average diameter.

According to one embodiment in step A2) the determining the cross-sectional shape of the filler profiles in a transverse section of a filler profile involves scaling a radius, which is half the average diameter, by means of the cosine of a core stranding angle of the cores. The scaling of the radius is by multiplication with the cosine of the core stranding angle of the cores.

According to one embodiment step B2) involves extruding the filler profiles.

According to one embodiment the power cable is a submarine power cable.

According to one embodiment the submarine power cable is one of a static or a dynamic submarine power cable.

The power cable may have a rating of at least 100 kV, such as at least 150 kV.

There is according to a second aspect of the present disclosure provided a power cable obtainable by means of the method of the first aspect.

Generally, all terms used in the claims are to be interpreted according to their ordinary meaning in the technical field, unless explicitly defined otherwise herein. All references to “a/an/the element, apparatus, component, means”, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 schematically shows a longitudinal section of a three-core power cable;

FIG. 2 is a perspective view of the cable in FIG. 1 with the section A-A visible;

FIG. 3 schematically shows a transverse section along lines A-A of the prior art power cable in FIG. 1;

FIG. 4 is a flowchart of a method of manufacturing a power cable comprising three cores and three filler profiles;

FIG. 5 shows a filler profile; and

FIG. 6 schematically shows a transverse section of a three-core power cable manufactured according to the method in FIG. 4.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

The present disclosure concerns a method of manufacturing a power cable comprising three cores and three filler profiles.

The power cable may be an AC power cable. Typically, all three cores are power cores. Alternatively, the power cable may be a DC power cable.

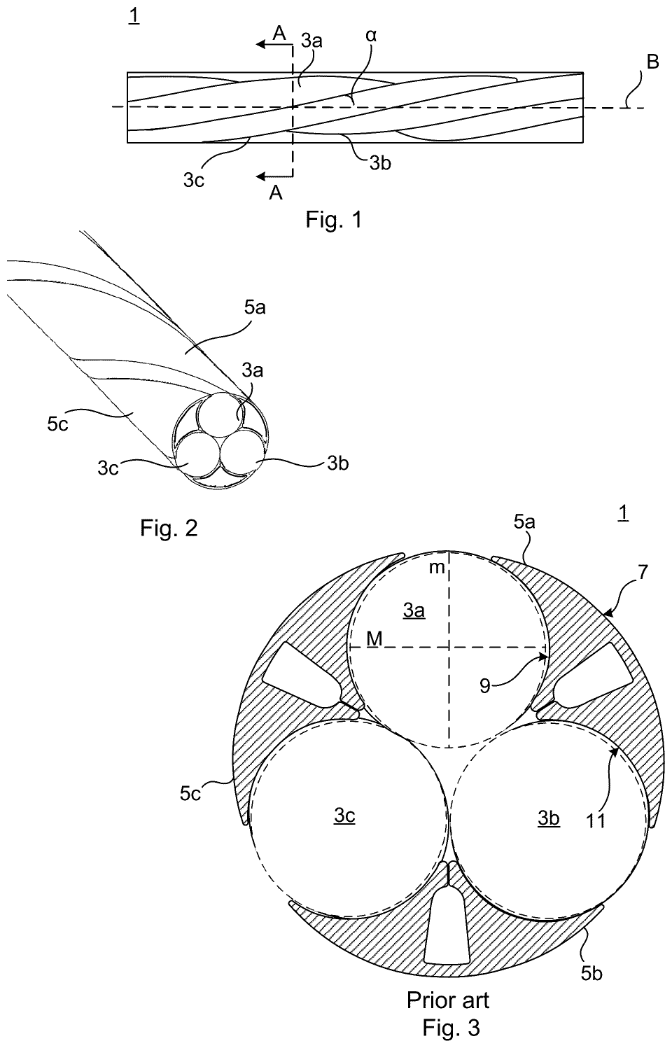

FIG. 1 schematically shows an axial section of a power cable 1 comprising three cores 3a-3c, and three filler profiles. For the purpose of illustration, only the three cores 3a-3c are shown inside the power cable 1.

Two or all three of the cores 3a-3c may comprise a central conductor, and an insulation system arranged around the central conductor. The insulation system may comprise an inner semiconducting layer arranged around the central conductor, an insulation layer arranged around the inner semiconducting layer, and an outer semiconducting layer arranged around the insulation layer.

The cores 3a-3c are arranged in a stranded configuration. The three cores 3a-3c are thus twisted during assembly of the power cable 1.

The cores 3a-3c are stranded with a core stranding angle α with respect to a central longitudinal axis B of the power cable 1. The core stranding angle α is thus the helix angle with which the cores 3a-3c are laid.

FIG. 2 also shows filler profiles 5a, 5c, which are helically wound or twisted together with the three cores 3a-3c.

The visual appearance of a transverse section of the power cable 1 is dependent of the core stranding angle α. A transverse section is a cross-section perpendicular to the central longitudinal axis B, dividing the power cable 1 in two axial lengths. The larger the core stranding angle α, i.e., the shorter the core stranding pitch, the more deformed the visual appearance of the cores 3a-3c will be in the transverse section. Instead of circular cross-sectional shapes of the generally cylindrical cores 3a-3c, the cores 3a-3c will appear approximately elliptical, or skewed elliptical, in a transverse plane of the power cable 1.

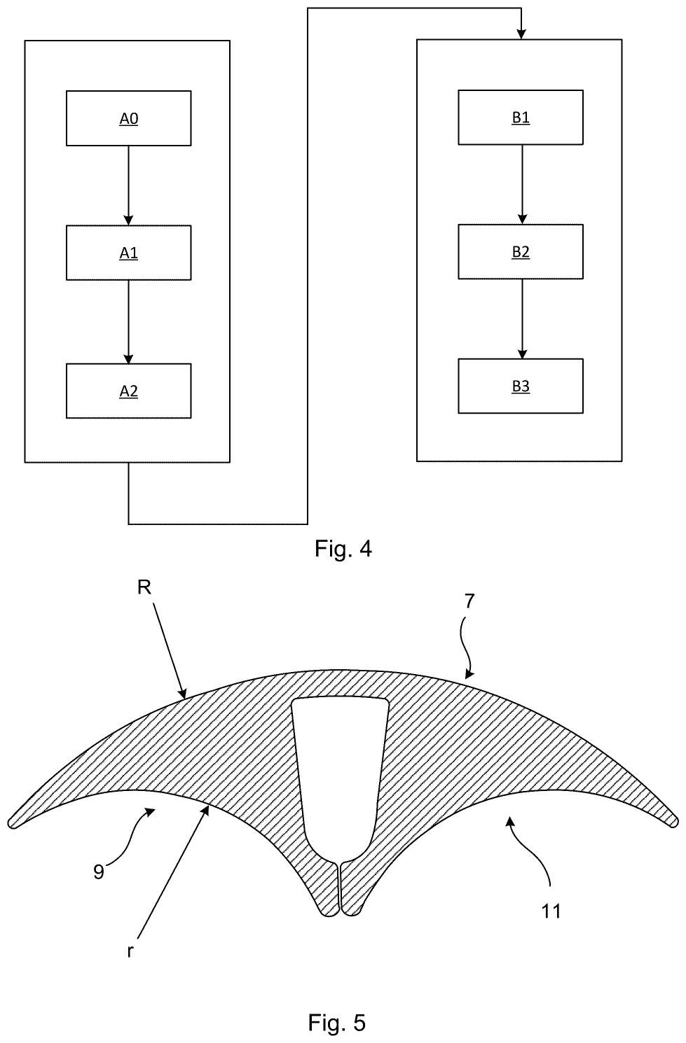

FIG. 3 schematically shows, with great exaggeration for illustrative purposes, the approximately elliptically shaped cores 3a-3c in the transverse section along lines A-A in FIG. 1 in the case of a prior art power cable 1.

In FIG. 3, the three filler profiles 5a-5c are also shown. The filler profiles 5a-5c are stranded together with the cores 3a-3c. The filler profiles 5a-5c are thus also laid with a helix angle which is the same as the core stranding angle α of the cores 3a-3c.

In the transverse plane of the power cable 1, each filler profile 5a-5c has a curved outer boundary 7 and two curved inner boundaries 9, 11. The curved outer boundary 7 forms an outer boundary of the filler profile 5a-5c and connects the two curved inner boundaries 9, 11. Each curved inner boundary surface 9, 11 which is adapted to bear against an outer surface of a respective core 3a-3c.

The three cores 3a-3c have an approximately elliptic shape in the transverse section of the power cable 1, with a major diameter M and a minor diameter m. This is due to the helical laying of the three cores 3a-3c. The major diameter M is the dimension of each core 3a-3c along the major axis of the core 3a-3c and the minor diameter m is the dimension of the core 3a-3c along the minor axis. The minor diameter m is the same as the nominal outer diameter of each core 3a-3c. For illustrative purposes, the round shape of the cores 3a-3c, which would be visible in a transverse plane of the cores 3a-3c, is shown with dashed lines. These round shaped cores 3a-3c have the nominal outer diameter of the cores 3a-3c. While not clearly shown in FIG. 3, it can be understood that there are portions of the curved inner boundaries 9, 11 which are not in contact with the outer boundary/surface of the approximately elliptical cores 3a-3c.

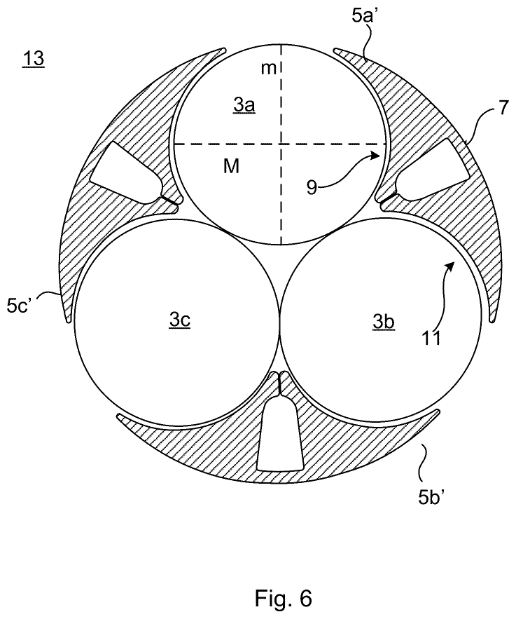

A method of manufacturing a power cable 13 comprising three cores 3a-3c and three filler profiles 5a′-5c′, shown in FIG. 6, with better fit between the cores 3a-3c and the filler profiles 5a′-5c′ due to a tailored design of the filler profiles 5a′-5c′ will now be described with reference to FIGS. 4-6.

The method is divided into two stages: a stage A) of designing the power cable 13, and a stage B) of manufacturing the power cable 13 in accordance with the design obtained in stage A).

The design stage comprises steps A0)-A2) described in the following.

In a step A0) a nominal outer diameter of the cores 3a-3c is defined. The nominal outer diameter is the outer diameter of the cores 3a-3c before the stranding process of the cores 3a-3c.

The nominal outer diameter may be defined based on for example the required rating of the power cable 13 to be manufactured, the conductor design and material, on water barrier design, if any, and polymeric material selections, as would be apparent to the person skilled in the art.

In step A0, the stranding pitch P of the cores 3a-3c is also defined. The core stranding pitch P and the nominal outer dimeter determine the core stranding angle α.

In a step A1) the shape of at least one of the cores 3a-3c in a transverse plane of the power cable 13 is determined. The shape is thus a cross-sectional shape of the core 3a-3c. The shape is approximately an ellipse or is approximately elliptical because it corresponds to a section along a tube, representing the core 3a-3c, at an angle which is not perpendicular to the longitudinal axis of the tube. The angle is the core stranding angle α.

Typically, all the cores 3a-3c have the same approximately elliptical shape in a transverse plane of the power cable 13 because they all have the same stranding pitch P. Therefore, it may be sufficient to determine the shape of only one of the cores 3a-3c in step A1).

According to one example, step A1) may involve determining the minor diameter m and the major diameter M of the approximately elliptically shaped core 3a-3c.

According to one example, step A1) may involve calculating the major diameter M and the minor diameter m of the core 3a-3c using a computational tool, using the stranding pitch P and the nominal outer diameter of the cores 3a-3c as input, to obtain the major diameter M and the minor diameter m.

According to another example, the major diameter M and the minor diameter m may be determined manually by measurement of a core 3a-3c in a transverse plane of a 3-dimensional model of the power cable 13 in which the cores 3a-3c have been stranded with the stranding pitch P and in which the cores 3a-3c have the nominal outer diameters defined in step A0. The 3-dimensional model may for example be a CAD model.

In a step A2) a cross-sectional shape of the filler profiles 5a′-5c′ is determined based on the shape determined in step A1). The cross-sectional shape is determined in a transverse section of a filler profile 5a′-5c′, i.e., a perpendicular section with respect to the longitudinal axis of the filler profile 5a′5c′.

The determining in step A2) may involve determining a curvature of each of the two curved inner boundaries to match with the shape of the core 3a-3c in a transverse section of the power cable 13. This matching may for example be done by drawing the two curved inner boundaries of the filler profile to perfectly follow the shape of the two cores 3a-3c that the filler profile in question faces.

In another example, prior to step A2), an average diameter may be determined based on an average of the major diameter M and the minor diameter m, i.e., the average diameter=(major diameter M+minor diameter m)/2. In step A2) the cross-sectional shape is then determined based on the average diameter. For example, a radius r, shown in FIG. 5, of the curved inner boundaries 9, 11 may in step A2) be set to be half the average diameter, i.e., average diameter/2. The radius r is determined for the filler profile in a transverse section of the power cable 13.

One example comprises, prior to step A2) estimating at least one three-core outer dimension of an assembly comprising the stranded cores 3a-3c, based on the shape obtained in step A1). The at least one three-core outer dimension may be a three-core diameter of the assembly. The three-core dimension may be determined as the diameter of a circle defined by the boundaries of the three cores 3a-3c in trefoil configuration. In both cases, in step A2) the cross-sectional shape is further based on the at least one three-core outer dimension. Hereto, a radius R of the curved outer boundary 7 of the filler profile 5a′-5c′ may be determined based on the three-core outer dimension of the assembly.

Once the curvature, or the radius r, of each of the two curved inner boundaries has been determined in the transverse section of the power cable 1, the curvature or curvatures, or radius r, of the two curved inner boundaries is determined in transverse section of a filler profile. This is because the filler profiles are manufactured in straight extrusion.

The curvature, or the radius, of each of the two curved inner boundaries in transverse section of a filler profile may be determined by scaling the curvature, or according to one example the respective curvature, if they differ, or radius r by means of the cosine of the core stranding angle α. For example, the radius of each of the two curved inner boundaries in transverse section of a filler profile may be determined by r*cos(α), where α is the core stranding angle, and r is the radius of a curved inner boundary in the transverse section of the power cable 13 as described above.

The production stage B) of the power cable 13, based on the design obtained in stage A), comprises steps B1)-B3) described in the following. The power cable 13 may be a submarine power cable, i.e., a static or a dynamic submarine power cable.

In a step B1) each of the cores 3a-3c is manufactured with the nominal outer diameter.

Step B1) may comprise providing a conductor and building of an insulation system around the conductor. The insulation system may be a paper-based wound insulation system or a polymer-based extruded insulation system. The insulation system comprises an inner semiconducting layer arranged around the conductor, an insulation layer arranged around the inner semiconducting layer, and an outer semiconducting layer arranged around the insulation layer.

Step B1) may comprise providing a bedding layer around the insulation system. According to one example step B1) may comprise providing a metallic water barrier, such as a lead sheath, or a longitudinally welded metallic water barrier comprising copper, aluminium, or stainless steel around the insulation system, and around the bedding layer, if present. Step B1) may comprise extruding a polymer layer around the insulation system, e.g., around the metallic water barrier, if present.

In a step B2), which may be carried out before, simultaneously with, or after step B1), the filler profiles 5a′-5c′ are obtained with the cross-sectional shape obtained in step A2) of the design stage. Step B2) may involve manufacturing the filler profiles 5a′-5c′ by means of extrusion at the manufacturing site of the cores 3a-3c or it may involve obtaining the filler profiles 5a′-5c′ from an external supplier which has manufactured the filler profiles 5a′-5c′ according to specifications, including the cross-sectional shape obtained in step A2).

In a step B3) the cores 3a-3c and the filler profiles 5a′-5c′ are stranded with the stranding pitch P in an assembly machine. The assembled power cable 13 with a transverse section shown schematically in FIG. 5 is thus obtained. The filler profiles 5a′-5c′ thus have a better fit with the cores 3a-3c. The pressure by the filler profiles 5a′-5c′ onto the cores 3a-3c is therefore more evenly distributed, reducing the risk of the cores 3a-3c being damaged by the filler profiles 5a′-5c′.

The inventive concept has mainly been described above with reference to a few examples. However, as is readily appreciated by a person skilled in the art, other embodiments than the ones disclosed above are equally possible within the scope of the inventive concept, as defined by the appended claims.

1. A method of manufacturing a power cable having three cores and three filler profiles arranged in a stranded configuration, the method comprising:
A) in a design stage of the power cable:
A0) defining a nominal outer diameter of the cores, and defining a stranding pitch P of the cores,
A1) determining, in a transverse plane of the power cable, a shape of at least one of the cores,
A2) determining a cross-sectional shape of the filler profiles in a transverse section of a filler profile based on the shape determined in step A1),
B) in the production stage of the power cable:
B1) manufacturing each of the cores with the nominal outer diameter,
B2) obtaining the filler profiles with the cross-sectional shape obtained in step A2), and
B3) stranding the cores and the filler profiles with the stranding pitch P in an assembly machine.

2. The method as claimed in claim 1, comprising prior to step A2) estimating a three-core outer dimension of an assembly including the stranded cores, based on the shape obtained in step A1), wherein in step A2) the cross-sectional shape is further based on the three-core outer dimension.

3. The method as claimed in claim 1, wherein in cross-section, each filler profile has a curved outer boundary and two curved inner boundaries, wherein the curved outer boundary forms an outer boundary of the filler profile and connects the two curved inner boundaries, each of which is adapted to bear against an outer surface of a respective core.

4. The method as claimed in claim 3, wherein the determining in step A2) involves determining a curvature of each of the two curved inner boundaries to match with the shape of the core.

5. The method as claimed in claim 4 wherein in step A2) the determining the cross-sectional shape of the filler profiles in a transverse section of a filler profile involves scaling at least one of the curvatures by means of the cosine of a core stranding angle of the cores.

6. The method as claimed in claim 1, wherein the shape of the core is an ellipse, wherein step A1) involves determining by the major diameter and the minor diameter of the ellipse.

7. The method as claimed in claim 6, comprising, prior to step A2), determining an average diameter based on an average of the major diameter and the minor diameter, wherein in step A2) the cross-sectional shape is determined based on the average diameter.

8. The method as claimed in claim 7, wherein in step A2) the determining the cross-sectional shape of the filler profiles in a transverse section of a filler profile involves scaling a radius, which is half the average diameter, by means of the cosine of a core stranding angle of the cores.

9. The method as claimed in claim 1, wherein step B2) involves extruding the filler profiles.

10. The method as claimed in claim 1, wherein the power cable is a submarine power cable.

11. The method as claimed in claim 10, wherein the submarine power cable is one of a static and a dynamic submarine power cable.

12. A power cable obtainable by means of a method of manufacturing a power cable comprising three cores and three filler profiles arranged in a stranded configuration, the method including:
A) in a design stage of the power cable:
A0) defining a nominal outer diameter of the cores, and defining a stranding pitch P of the cores,
A1) determining, in a transverse plane of the power cable, a shape of at least one of the cores,
A2) determining a cross-sectional shape of the filler profiles in a transverse section of a filler profile based on the shape determined in step A1),
B) in the production stage of the power cable:
B1) manufacturing each of the cores with the nominal outer diameter,
B2) obtaining the filler profiles with the cross-sectional shape obtained in step A2), and
B3) stranding the cores and the filler profiles with the stranding pitch P in an assembly machine.

13. The method as claimed in claim 2, wherein in cross-section, each filler profile has a curved outer boundary and two curved inner boundaries, wherein the curved outer boundary forms an outer boundary of the filler profile and connects the two curved inner boundaries, each of which is adapted to bear against an outer surface of a respective core.

14. The method as claimed in claim 2, wherein the shape of the core is an ellipse, wherein step A1) involves determining by the major diameter and the minor diameter of the ellipse.

15. The method as claimed in claim 2, wherein step B2) involves extruding the filler profiles.

16. The method as claimed in claim 2, wherein the power cable is a submarine power cable.
